(19) United States
(12) Patent Application Publication
(10) Pub. No.: US 2012/0005124 A1
(43) Pub. Date: Jan. 5, 2012

(54) ROTH-AWARE FINANCIAL ADVISORY PLATFORM

(75) Inventors: Wei-Yin Hu, Menlo Park, CA (US); Dolores A. Upton, Fremont, CA (US); Irene Gitin, Sunnyvale, CA (US)

(73) Assignee: Financial Engines, Inc., a Delaware Corporation, Palo Alto, CA (US)

(21) Appl. No.: 13/233,461

(22) Filed: Sep. 15, 2011

Related U.S. Application Data
(62) Division of application No. 12/548,840, filed on Aug. 27, 2009.

(51) Int. Cl. G06Q 40/00

(52) U.S. Cl. 705/36 T

(57) ABSTRACT

A financial advisory platform that includes Roth contribution support is provided. According to one embodiment, a method is provided for identifying an alternative retirement savings strategy that maintains take-home pay and increases a forecasted after tax value of a retirement portfolio. A split optimization module determines whether there exists an alternative retirement savings strategy for an investor that both (i) maintains take-home pay of an investor and (ii) increases a forecasted after tax value of a retirement portfolio of the investor as compared to a current retirement savings strategy of the investor. If the alternative retirement savings strategy exists, then a user interface module presents information associated with the alternative retirement savings strategy, including information regarding a recommended periodic contribution by the investor to be invested in the retirement portfolio and information regarding a target proportion of the recommended periodic contribution that should be made pre-tax and post-tax.

### CROSS-REFERENCE TO RELATED APPLICATIONS

This application is a divisional of U.S. patent application Ser. No. 12/548,840, filed on Aug. 27, 2009, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright ©2009-2011, Financial Engines, Inc.

### BACKGROUND

1. Field

Embodiments of the present invention generally relate to the field of financial advisory services. In particular, embodiments of the present invention relate to a system for advising an end user (e.g., an investor, a financial advisor (e.g., a series 6 platform representative, a series 7 advisor, or other investment advisor or bank representative) or an independent investment manager) regarding feasible and recommended products from a set of financial products and a user interface for such a system that includes Roth contribution support, including, but not limited to one or more of awareness of Roth contribution limits, projection of Roth wealth within an account, forecast sensitivity to after-tax impact of Roth, Roth-aware savings advice and alternative scenario generation or “what if” capabilities that allow interactive exploration of forecast and take-home pay consequences of different pre-tax/Roth splits coupled with different annual contribution amounts.

2. Description of the Related Art

The advent of a designated Roth contribution program, in a 401(k) plan or a 403(b) plan (hereafter for simplicity referred to as a “Roth 401(k)”) significantly expanded opportunities for tax-preferred retirement saving, but at the same time it created much confusion for individual savers regarding whether to save in the form of pre-tax or Roth dollars. The financial community's conventional wisdom is based primarily upon comparing current and future expected tax rates.

Many authors in the investment industry and the financial press have described clearly the fact that whether pre-tax or Roth is preferred depends heavily on the difference between current and future tax rates. The basic logic can be replicated succinctly as follows. Suppose an individual has $W of pre-tax (gross) salary that he is considering saving in either pre-tax or Roth dollars. If he saves pre-tax, then his after-tax wealth at retirement can be calculated as

W_{AT}=$W×(1+R)^{T}×(1−t_{RET})

where R represents a rate of return (assumed to be constant for simplicity), T is the years until retirement, and t_{RET} is the tax rate in retirement.

In contrast, if he were to save as Roth dollars, his after-tax wealth at retirement is

W_{AT}=$W×(1−t_{NOW})×(1+R)^{T}

where t_{NOW} is his tax rate today. It is to be noted that the ratio of the two after-tax wealth values is independent of the rate of return and the time horizon: the only determinant is the ratio of (one minus) the tax rates. For later use, the relative advantage of pre-tax over Roth savings is defined as (1−t_{RET})/(1−t_{NOW})−1. Thus, according to this logic, if the tax rate today is higher than the tax rate in retirement, then the individual is better off saving pre-tax dollars than Roth dollars.

Relying solely on the above-noted conventional wisdom can be wrong in various circumstances discussed below. Consequently, there is a need in the art for improved financial advisory platforms that include Roth contribution support.

### SUMMARY

A financial advisory platform is described that includes Roth contribution support. According to one embodiment, a method is provided for identifying an alternative retirement savings strategy that maintains take-home pay and increases a forecasted after tax value of a retirement portfolio. A split optimization module determines whether there exists an alternative retirement savings strategy for an investor that both (i) maintains take-home pay of an investor and (ii) increases a forecasted after tax value of a retirement portfolio of the investor as compared to a current retirement savings strategy of the investor. If the alternative retirement savings strategy exists, then a user interface module presents information associated with the alternative retirement savings strategy, including information regarding a recommended periodic contribution by the investor to be invested in the retirement portfolio and information regarding a target proportion of the recommended periodic contribution that should be made pre-tax and post-tax.

In the aforementioned embodiment, the pre-tax contributions may represent contributions to a traditional component of a 401(k) plan or a 403(b) plan and the post-tax contributions may represent contributions to a Roth component of the 401(k) plan or the 403(b) plan.

In various instances of the aforementioned embodiments, the method may further involve replacing the current retirement savings strategy with the alternative retirement savings strategy.

Other embodiments of the present invention provide a method for identifying an alternative retirement savings strategy that increases take-home pay and maintains or increases a forecasted after tax value of a retirement portfolio. A split optimization module determines whether there exists an alternative retirement savings strategy for an investor that both (i) increases take-home pay of the investor and (ii) maintains or increases a forecasted after tax value of a retirement portfolio of the investor as compared to a current retirement savings strategy of the investor. If the alternative retirement savings strategy exists, then a user interface module presents information associated with the alternative retirement savings strategy, including information regarding a recommended periodic contribution by the investor to be invested in the retirement portfolio and information regarding a target proportion of the recommended periodic contribution that should be made pre-tax and post-tax.

In the aforementioned embodiment, the pre-tax contributions may represent contributions to a traditional component of a 401(k) plan or a 403(b) plan and the post-tax contributions may represent contributions to a Roth component of the 401(k) plan or the 403(b) plan.

In various instances of the aforementioned embodiments, the method may further involve replacing the current retirement savings strategy with the alternative retirement savings strategy.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a financial advisory system in which embodiments of the present invention may be employed.

FIG. 2 is a block diagram conceptually illustrating various analytic modules in accordance with one embodiment of the present invention.

FIG. 3 is an example of a computer system with which embodiments of the present invention may be utilized.

FIG. 4 illustrates a tax rate input screen in accordance with an embodiment of the present invention.

FIG. 5 illustrates a pre-tax/Roth contribution splits and annual contribution amounts input screen framed with some initial split guidance in accordance with an embodiment of the present invention.

FIG. 6 illustrates an analysis screen in accordance with an embodiment of the present invention.

FIG. 7 is a flow diagram illustrating user-driven savings trade-off exploration processing in accordance with an embodiment of the present invention.

FIG. 8 is a flow diagram illustrating a process of automatically identifying an alternative strategy that increases/maintains take-home pay while maintaining/increasing forecasted account value in accordance with an embodiment of the present invention.

FIG. 9 is a flow diagram illustrating core asset class scenario generation according to one embodiment of the present invention.

FIG. 10 is a flow diagram illustrating factor asset class scenario generation according to one embodiment of the present invention.

FIG. 11 is a flow diagram illustrating financial product exposure determination according to one embodiment of the present invention.

### DETAILED DESCRIPTION

A financial advisory platform is described that includes Roth contribution support. In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

In various embodiments, the end user and investor may be at times discussed as if they are separate individuals. Such a situation may arise when an advisor-client relationship exists, for example, between the ultimate end user of a financial advisory service providing advice in accordance with various embodiments of the present invention and the person whose account (or portion thereof) is being managed; however, it is recognized that the user and the investor may be one in the same. Consequently, it is to be noted that embodiments of the present invention are not limited to scenarios in which an end user interacts with a financial advisory system on behalf of a separate investor.

### TERMINOLOGY

Brief definitions of terms used throughout this application are given below.

The terms “connected” or “coupled” and related terms are used in an operational sense and are not necessarily limited to a direct connection or coupling.

The term “client” generally refers to an application, program, process or device in a client/server relationship that requests information or services from another program, process or device (a server) on a network. Importantly, the terms “client” and “server” are relative since an application may be a client to one application but a server to another. The term “client” also encompasses software that makes the connection between a requesting application, program, process or device to a server possible, such as an email client.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

The term “server” generally refers to an application, program, process or device in a client/server relationship that responds to requests for information or services by another program, process or device (a server) on a network. The term “server” also encompasses software that makes the act of serving information or providing services possible. The term “server” also encompasses software that makes the act of serving information or providing services possible.

### Overview

As discussed above, the financial community's conventional wisdom regarding whether to save in the form of pre-tax or Roth dollars is based on comparing current and future tax rates; however, relying solely on such conventional wisdom can be wrong. As an initial matter, the amount of saving should not be judged by how many dollars are contributed into an account, but by the tax-equivalent amount saved. A dollar of pre-tax saving is actually equivalent to less than a dollar of Roth saving, due to the future tax liability. Stated another way, comparing different saving strategies should be done in the context of an apples-to-apples comparison, for example, by keeping take-home pay constant.

An individual currently saving pre-tax can maintain the same take-home pay by switching to a lower amount of Roth savings. However, some important rules imposed by either 401(k) plans or the Internal Revenue Service (IRS) encourage “tax illusion” by treating pre-tax and Roth dollars as if they were equivalent. First, moderate savers need to understand how switching to Roth saving could lose them free money that would otherwise be available in the form of employer matching contributions. Second, the IRS limit on annual 401(k) contributions means that aggressive savers who save Roth dollars can save more in a tax-advantaged way than those who save pre-tax dollars. For both of these groups, the conventional wisdom can be completely reversed under fairly normal circumstances.

Modest savers may do better by saving in pre-tax dollars because employer match formulas are expressed as a percentage of employee contributions, regardless of whether those employee dollars are pre-tax or Roth. For example, an individual might be able to afford to save 4 percent Roth, but an equivalent take-home pay strategy would save 6 percent pre-tax if that individual faces a 33 percent tax rate. The employer match on that incremental 2 percent may outweigh the effects of a higher tax rate in retirement (which favors Roth saving according to conventional wisdom), to make such an individual prefer to save pre-tax.

For individuals saving larger amounts, an important consideration is the fact that the IRS contribution limit (currently, $16,500 in annual contributions) is applied to pre-tax and Roth dollars collectively, despite the fact that a Roth dollar is effectively more savings than a pre-tax dollar. As a result, a true apples-to-apples comparison requires that someone considering saving $16,500 in Roth would need to compare that with saving $16,500 in pre-tax plus some additional amount in another form (because a dollar of pre-tax saving is actually equivalent to less than a dollar of Roth saving, due to the future tax liability). Notably, these latter strategies may lose much of the advantage that pre-tax savings would confer under the above-noted conventional wisdom. The decision may tilt enough to favor saving in the Roth form, even for individuals facing lower tax rates in retirement.

Additional data and examples supporting these conclusions can be found in Hu, Wei-Yin, Who Should Save in a Roth 401(K)? (It's Not Just About Tax Rates) (May 27, 2009), which is currently available on the Social Science research Network (SSRN) website at http://papers.ssrn.com/sol3/papers.cfm?abstract_id=1410821 and which is hereby incorporated by reference in its entirety for all purposes.

Having highlighted various scenarios in which conventional wisdom arrives at the wrong decision between saving in the form of pre-tax versus Roth dollars, a financial advisory system that includes Roth contribution support, including, but not limited to one or more of awareness of Roth contribution limits, projection of Roth wealth within an account, forecast sensitivity to after-tax impact of Roth, Roth-aware savings advice and alternative scenario generation or “what if” capabilities that allow interactive exploration of forecast and take-home pay consequences of different pre-tax/Roth splits coupled with different annual contribution amounts, will now be described in accordance with embodiments of the present invention.

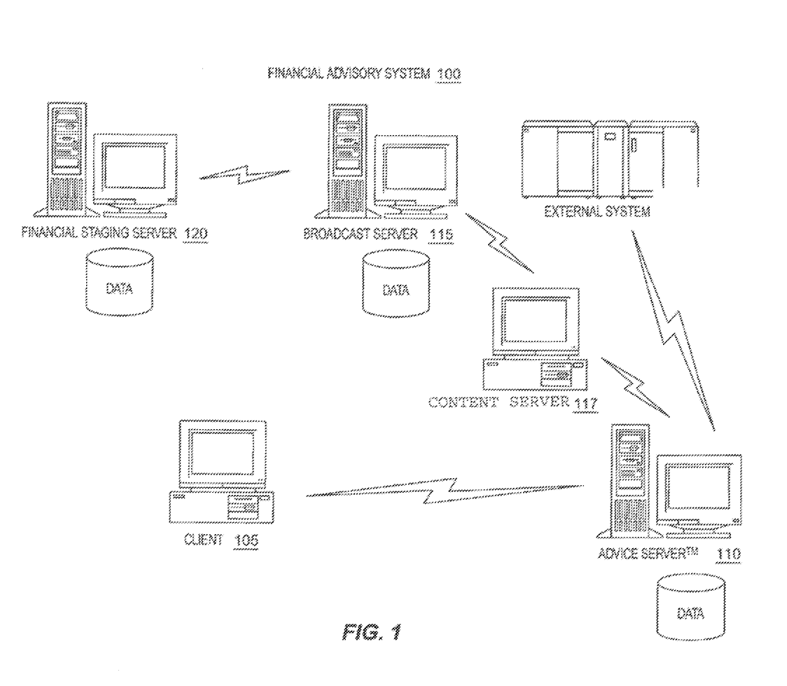

FIG. 1 illustrates a financial advisory system 100 in which embodiments of the present invention may be employed. According to the present example, financial advisory system 100 includes a financial staging server 120, a broadcast server 115, a content server 117, an AdviceServer™ 110 (AdviceServer™ is a trademark of Financial Engines, Inc., the assignee of the present invention), and a client 105.

The financial staging server 120 may serve as a primary staging and validation area for the publication of financial content. In this manner, the financial staging server 120 acts as a data warehouse. Raw source data, typically time series data, may be refined and processed into analytically useful data on the financial staging server 120. On a monthly basis, or whatever the batch processing interval may be, the financial staging server 120 converts raw time series data obtained from data vendors from the specific vendor's format into a standard format that can be used throughout the financial advisory server 100. Various financial engines may be run to generate data for validation and quality assurance of the data received from the vendors. Additional engines may be run to generate module inputs, model parameters, and intermediate calculations needed by the system based on raw data received by the vendors. Any calibrations of the analytic data needed by the financial engines may be performed prior to publishing the final analytic data to the broadcast server 115.

According to one embodiment, the broadcast server 115 is a database server. As such, it runs an instance of a Relational Database Management System (RDBMS), such as Microsoft SQL-Server, Oracle or the like. The broadcast server 115 provides a single point of access to all fund information and analytic data. When advice servers, such as AdviceServer 110, need data they may query information from the broadcast server database. The broadcast server 115 may also populate content servers, such as content server 117, so remote implementations of the AdviceServer 110 need not communicate directly with the broadcast server 115.

The AdviceServer 110 is the primary provider of services for the client 105. The AdviceServer 110 also acts as a proxy between external systems, such as external system 125, and the broadcast server 115 or the content server 117. The AdviceServer 110 is the central database repository for holding user profile and portfolio data. In this manner, ongoing portfolio analysis may be performed and alerts may be triggered, as described further below.

According to the embodiment depicted, an end user (e.g., an individual investor accessing the system on his/her own behalf, an investment advisor representative that advises one or more investors on investment matters on a professional basis, a call center representative or the like) may interact with and receive feedback from the financial advisory system 100 using client software which may be running within a browser application or as a standalone desktop application on the end user's personal computer or work station 105. The client software communicates with the AdviceServer 110 which acts as a HyperText Transfer Protocol (HTTP) server.

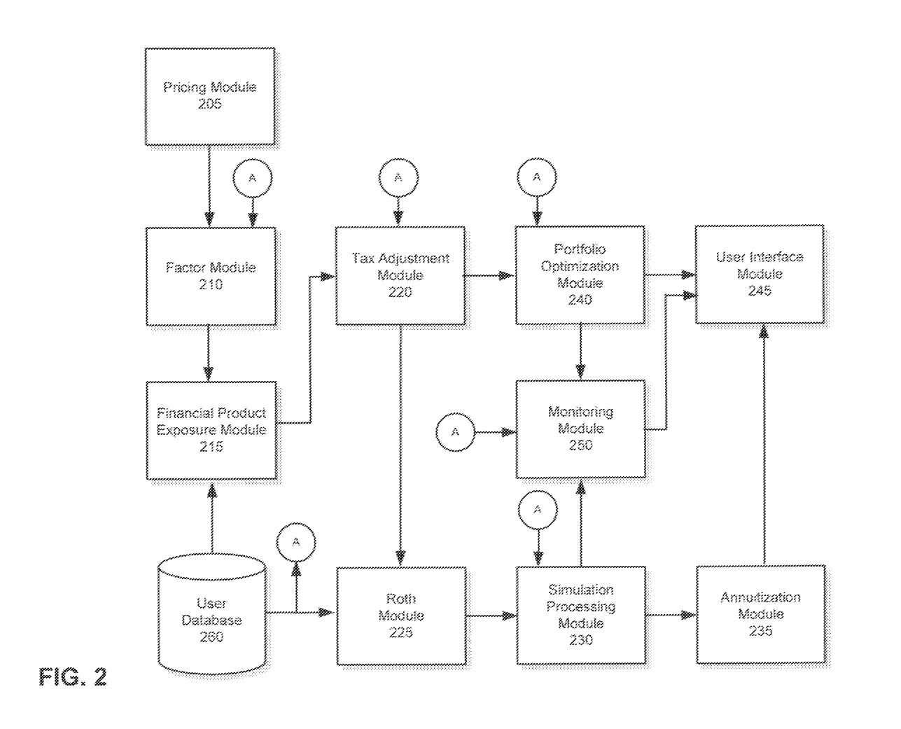

FIG. 2 is a block diagram conceptually illustrating various analytic modules of the financial advisory system 100 in accordance with one embodiment of the present invention. According to the current example, the following modules are provided: a pricing module 205, a factor module 210, a financial product exposure module 215, a tax adjustment module 220, a Roth module 225, a simulation processing module 230, an annuitization module 235, a portfolio optimization module 240 and a user interface (UI) module 245. It should be appreciated that the functionality described herein may be implemented in more or less modules than discussed below. Additionally, the modules and functionality may be distributed in various configurations among a client system, such as client 105 and one or more server systems, such as the financial staging server 120, the broadcast server 115, or the AdviceServer 110. The functionality of each of the exemplary modules will now be briefly described.

An “econometric model” is a statistical model that provides a means of forecasting the levels of certain variables referred to as “endogenous variables,” conditional on the levels of certain other variables, known as “exogenous variables,” and in some cases previously determined values of the endogenous variables (sometimes referred to as lagged dependent variables). According to one embodiment, the pricing module 205 is an equilibrium econometric model for forecasting prices and returns (also referred to herein as “core asset scenarios”) for a set of core asset classes. The pricing module provides estimates of current levels and forecasts of economic factors (also known as state variables), upon which the estimates of core asset class returns are based. According to one embodiment of the present invention, the economic factors may be represented with three exogenous state variables, price inflation, a real short-term interest rate, and dividend growth. The three exogenous state variables may be fitted with autoregressive time series models to match historical moments of the corresponding observed economic variables, as described further below and/or as described in U.S. Pat. No. 6,125,355, which is hereby incorporated by reference in its entirety for all purposes.

In any event, the resulting core asset classes are the foundation for portfolio simulation and are designed to provide a coherent and internally consistent (e.g., no arbitrage) set of returns. By arbitrage what is meant is an opportunity to create a profitable trading opportunity that involves no net investment and positive values in all states of the world.

According to one embodiment, the core asset classes include short-term US government bonds, long-term US government bonds, and US equities. To expand the core asset classes to cover the full range of possible investments that people generally have access to, additional asset classes may be incorporated into the pricing module 205 or the additional asset classes may be included in the factor model 210 and be conditioned on the core asset classes, as discussed further below.

In one embodiment, based upon the core asset scenarios generated by the pricing module 205, the factor module 210 produces return scenarios (also referred to herein as “factor model asset scenarios”) for a set of factor asset classes that are used for both exposure analysis, such as style analysis, and the simulation of portfolio returns. The additional asset classes, referred to as factors, represented in the factor model are conditional upon the core asset class return scenarios generated by the pricing module 205. According to one embodiment, these additional factors may correspond to a set of asset classes or indices that are chosen in a manner to span the range of investments typically available to individual investors in mainstream mutual funds and defined contribution plans. For example, the factors may be divided into the following groups: cash, bonds, equities, and foreign equities. The equities group may further be broken down into two different broad classifications (1) value versus growth and (2) market capitalization. Growth stocks are basically stocks with relatively high prices relative to their underlying book value (e.g., high price-to-book ratio). In contrast, value stocks have relatively low prices relative to their underlying book value. With regard to market capitalization, stocks may be divided into groups of large, medium, and small capitalization. An exemplary set of factors is listed below in Table 1.

### Exemplary Set of Factors

TABLE 1

| Group | Factor |
|---|---|
| Cash: | Short Term US Bonds (core class) |
| Bonds: | Intermediate-term US Bonds (core class) |
| | Long-term US Bonds (core class) |
| | US Corporate Bonds |
| | US Mortgage Backed Securities |
| | Non-US Government Bonds |
| Equities: | Large Cap Stock - Value |
| | Large Cap Stock - Growth |
| | Mid Cap Stock - Value |
| | Mid Cap Stock - Growth |
| | Small Cap Stock - Value |
| | Small Cap Stock - Growth |
| Foreign: | International Equity - Europe |
| | International Equity - Pacific |
| | International Equity - Emerging Markets |

At this point it is important to point out that more, less, or a completely different set of factors maybe employed depending upon the specific implementation. The factors listed in Table 1 are simply presented as an example of a set of factors that achieve the goal of spanning the range of investments typically available to individual investors in mainstream mutual funds and defined contribution plans. It will be apparent to those of ordinary skill in the art that alternative factors may be employed. In particular, it is possible to construct factors that represent functions of the underlying asset classes for pricing of securities that are nonlinearly related to the prices of certain asset classes (e.g., derivative securities). In other embodiments of the present invention, additional factors may be relevant to span a broader range of financial alternatives, such as industry specific equity indices.

On a periodic basis, the financial product exposure module 215 maps financial product returns onto the factor model. In one embodiment, the process of mapping financial product returns onto the factor model comprises decomposing financial product returns into exposures to the factors. The mapping, in effect, indicates how the financial product returns behave relative to the returns of the factors. According to one embodiment, the financial product mapping module 215 is located on one of the servers (e.g., the financial staging server 120, the broadcast server 115, or the AdviceServer 110). In alternative embodiments, the financial product mapping module 315 may be located on the client 105.

In one embodiment of the present invention, an external approach referred to as “returns-based style analysis” is employed to determine a financial product's exposure to the factors. The approach is referred to as external because it does not rely upon information that may be available only from sources internal to the financial product. Rather, in this embodiment, typical exposures of the financial product to the factors may be established based simply upon realized returns of a financial product, as described further below. For more background regarding returns-based style analysis see Sharpe, William F. “Determining a Fund's Effective Asset Mix,” Investment Management Review, December 1988, pp. 59 69 and Sharpe, William F. “Asset Allocation: Management Style and Performance Measurement,” The Journal of Portfolio Management, 18, no. 2 (Winter 1992), pp. 7 19 (“Sharpe [1992]”), which is incorporated by reference herein in its entirety for all purposes.

Alternative approaches to determining a financial product's exposure to the factors include surveying the underlying assets held in a financial product (e.g. a mutual fund) via information filed with regulatory bodies, categorizing exposures based on standard industry classification schemes (e.g. SIC codes), identifying the factors exposures based on analysis of the structure of the product (e.g. equity index options, or mortgage backed securities), and obtaining exposure information based on the target benchmark from the asset manager of the financial product. In each method, the primary function of the process is to determine the set of factor exposures that best describes the performance of the financial product.

The tax adjustment module 220 takes into account tax implications of the financial products and financial circumstances of the investor. For example, the tax adjustment module 220 may provide methods to adjust taxable income and savings, as well as estimates for future tax liabilities associated with early distributions from pension and defined contribution plans, and deferred taxes from investments in qualified plans. Further, the returns for financial products held in taxable investment vehicles (e.g. a traditional (non-Roth) after-tax account, such as a standard brokerage account, a non-deductible Individual Retirement Account (IRA) or the like) may be adjusted to take into account expected tax effects for both accumulations and distributions. For example, the component of returns attributable to dividend income should be taxed at the investor's income tax rate and the component of returns attributable to capital gains should be taxed at an appropriate capital gains tax rate depending upon the holding period.

Additionally, the tax module 220 may forecast future components of a financial product's total return due to dividend income versus capital gains based upon one or more characteristics of the financial product including, for example, the active or passive nature of the financial product's management, turnover ratio, and category of financial product. This allows precise calculations incorporating the specific tax effects based on the financial product and financial circumstances of the investor. Finally, the tax module 220 facilitates tax efficient investing by determining optimal asset allocation among taxable accounts (e.g., brokerage accounts) and nontaxable accounts (e.g., IRA, or employer sponsored 401(k) plan). In this manner the tax module 320 is designed to estimate the tax impact for a particular investor with reference to that particular investor's income tax rates, capital gains rates, and available financial products. Ultimately, the tax module 220 produces tax-adjusted returns for each available financial product and tax-adjusted distributions for each available financial product.

In one embodiment, Roth module 225 provides Roth contribution support, including, but not limited to, awareness of Roth contribution limits, projection of Roth wealth within an account, forecast sensitivity to after-tax impact of Roth, Roth-aware savings advice and alternative scenario generation or “what if” capabilities that allow interactive exploration of forecast and take-home pay consequences of different pre-tax/Roth splits coupled with different annual contribution amounts. Additional details regarding savings trade-off exploration processing in the context of various embodiments are described further below.

According to one embodiment, portfolio optimization module 240 calculates the utility maximizing set of financial products under a set of constraints defined by the user and the available feasible investment set. In one embodiment, the calculation is based upon a mean-variance optimization of the financial products. The constraints defined by the user may include bounds on asset class and/or specific financial product holdings. In addition, users can specify intermediate goals of the investor, such as buying a house or putting a child through college, for example, that are incorporated into the optimization. Thus, depending upon the particular implementation, the optimization may explicitly take into account the impact of future contributions and expected withdrawals on the optimal asset allocation. Additionally, the covariance matrix used during optimization is calculated based upon the forecasts of expected returns for the factors generated by the factor module 210 over the investment time horizon. As a result, the portfolio optimization module 240 may explicitly take into account the impact of different investment horizons, including the horizon impact of intermediate contributions and withdrawals.

The simulation processing module 230 provides additional analytics for the processing of raw simulated return scenarios into statistics that may be displayed to the user via the UI 245. In the one embodiment of the present invention, these analytics generate statistics such as the probability of attaining a certain goal, or the estimated time required to reach a certain level of assets with a certain probability. The simulation processing module 230 may also incorporate methods to adjust the simulated scenarios for the effects induced by sampling error in relatively small samples. The simulation processing module 230 provides the user with the ability to interact with the portfolio scenarios generated by the portfolio optimization module 240 in real-time.

In various embodiments, annuitization module 225 provides a meaningful way of representing the investor's portfolio value at the end of the term of the investment horizon. According to one embodiment, the user may be provided with information indicative of the total projected portfolio value before or after taxes. Alternatively, the projected portfolio value before or after tax at retirement may be distributed over the length of retirement by dividing the projected portfolio value by the length of retirement.

According to one embodiment, one way of conveying the information to the user is converting the projected portfolio value into a retirement income number. The projected portfolio value before or after tax at retirement may be distributed over the length of retirement by dividing the projected portfolio value by the length of retirement. More sophisticated techniques may involve determining how much the projected portfolio value will grow during retirement and additionally consider the effects of inflation. However, these approaches assume the length of the retirement period is known in advance. Consequently, in accordance with various embodiments, the user may be presented with a retirement income number that is more representative of an actual standard of living that could be locked in for the duration of the investor's retirement. According to one embodiment, this retirement income number represents the inflation adjusted income that would be guaranteed by a real annuity purchased from an insurance company or synthetically created via a trading strategy involving inflation-indexed treasury bond securities. In this manner, the mortality risk is taken out of the picture because regardless of the length of the retirement period, the investor would be guaranteed a specific annual real income. To determine the retirement income number, standard methods of annuitization employed by insurance companies may be employed. Additionally, mortality probabilities for an individual of a given age, risk profile, and gender may be based on standard actuarial tables used in the insurance industry. For more information see Bowers, Newton L. Jr., et al, “Actuarial Mathematics,” The Society of Actuaries, Itasca, Ill., 1986, pp. 52 59 and Society of Actuaries Group Annuity Valuation Table Task Force, “1994 Group Annuity Mortality Table and 1994 Group Annuity Reserving Table,” Transactions of the Society of Actuaries, Volume XLVII, 1994, pp. 865 913. Calculating the value of an inflation-adjusted annuity value may involve estimating the appropriate values of real bonds of various maturities. The pricing module 205 generates the prices of real bonds used to calculate the implied real annuity value of the portfolio at the investment horizon.

Referring now to monitoring module 250, a mechanism is provided for alerting the user of the occurrence of various predetermined conditions involving characteristics of the recommended portfolio. Because the data upon which the portfolio optimization module 240 depends is constantly changing, characteristics of the recommended portfolio may be reevaluated on a periodic basis so that the user may be notified in a timely manner when there is a need for him/her to take affirmative action, for example. According to one embodiment, monitoring module 250 is located on the AdviceServer 110. In this manner, monitoring module 250 has constant access to the investor/user profile and portfolio data.

In one embodiment, the occurrence of three basic conditions may cause monitoring module 250 to trigger a notification or alert to the user. The first condition that may trigger an alert to the user is the current probability of achieving a goal (e.g., achieving a particular annual or monthly retirement income level) falling outside of a predetermined tolerance range of the desired probability of achieving the particular goal. Typically, a goal is a financial goal, such as a certain retirement income or the accumulation of a certain amount of money to put a child through college, for example. Additionally, the monitoring module 250 may alert the user even if the current probability of achieving the financial goal is within the predetermined tolerance range if a measure of the currently recommended portfolio's utility has fallen below a predetermined tolerance level. Finally, the monitoring module 250 may alert the user that he/she may wish to review the investor's current savings split between pre-tax and Roth savings. For example, it may be the case that the investor can increase take-home pay while achieving an equal or better retirement income forecast or the investor may be able to maintain his/her current take-home pay and achieve a better retirement income forecast. Various other conditions are contemplated that may cause alerts to be generated. For example, if the nature of the financial products in the currently recommended portfolio has changed such that the risk of the portfolio is outside the investor's risk tolerance range, the user may receive an indication that he/she should rebalance the portfolio.

The UI module 245 provides mechanisms for data input and output to provide the user with a means of interacting with and receiving feedback from the financial advisory system 100, respectively. A description regarding exemplary UI screen shots that may be employed according to one embodiment of the present invention is presented below. Additional details regarding other UI screen shots that may be used in the context of various embodiments are described in U.S. Pat. No. 6,012,044, which is hereby incorporated by reference in its entirety for all purposes.

Other modules maybe included in the financial advisory system 100 such as a pension module (not shown) and a social security module (not shown). The pension module may be provided to estimate pension benefits and income. The social security module may provide estimates of the expected social security income that an individual will receive upon retirement. The estimates may be based on calculations used by the Social Security Administration (SSA), and on probability distributions for reductions in the current level of benefits.

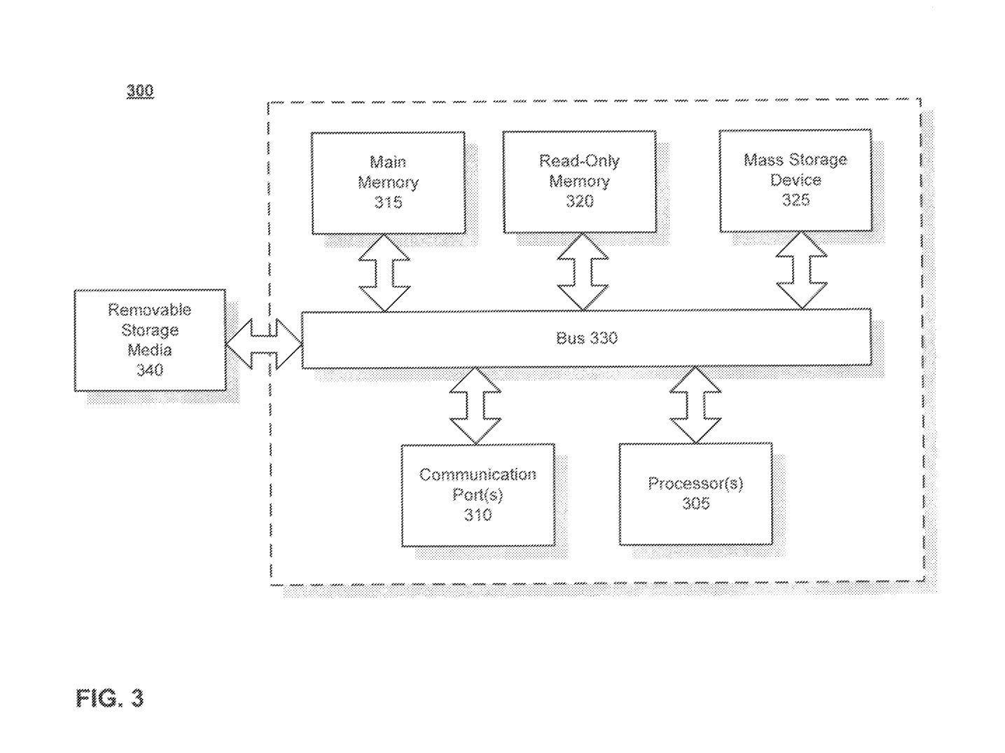

FIG. 3 is an example of a computer system 300 with which embodiments of the present invention may be utilized. The computer system 300 may represent or form a part of the client 105 or the servers 110, 115, 117 and 120 and/or other devices implementing some subset of functionality of the client 105, such servers or the functional units depicted in FIG. 2. Embodiments of the present invention include various steps, which will be described in more detail below. A variety of these steps may be performed by hardware components or may be embodied in machine-executable instructions, which may be used to cause a general-purpose or special-purpose processor programmed with instructions to perform these steps. Alternatively, the steps may be performed by a combination of hardware, software, and/or firmware.

According to the present example, the computer system includes a bus 330, one or more processors 305, one or more communication ports 310, a main memory 315, a removable storage media 340, a read only memory 320 and a mass storage 325.

Processor(s) 305 can be any future or existing processor, including, but not limited to, an Intel® Itanium® or Itanium 2 processor(s), or AMD® Opteron® or Athlon MP® processor(s), or Motorola® lines of processors. Communication port(s) 310 can be any of an RS-232 port for use with a modem based dialup connection, a 10/100 Ethernet port, a Gigabit port using copper or fiber or other existing or future ports. Communication port(s) 310 may be chosen depending on a network, such a Local Area Network (LAN), Wide Area Network (WAN), or any network to which the computer system 300 connects.

Main memory 315 can be Random Access Memory (RAM), or any other dynamic storage device(s) commonly known in the art. Read only memory 320 can be any static storage device(s) such as Programmable Read Only Memory (PROM) chips for storing static information such as start-up or BIOS instructions for processor 305.

Mass storage 325 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 330 communicatively couples processor(s) 305 with the other memory, storage and communication blocks. Bus 330 can include a bus, such as a Peripheral Component Interconnect (PCI)/PCI Extended (PCI-X), Small Computer System Interface (SCSI), USB or the like, for connecting expansion cards, drives and other subsystems as well as other buses, such a front side bus (FSB), which connects the processor(s) 305 to system memory.

Optionally, operator and administrative interfaces, such as a display, keyboard, and a cursor control device, may also be coupled to bus 330 to support direct operator interaction with computer system 300. Other operator and administrative interfaces can be provided through network connections connected through communication ports 310.

Removable storage media 340 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

According to one embodiment, one or more of the modules of FIG. 2 may be tangibly embodied on one or more computer readable media (e.g., main memory 315, read-only memory 320, mass storage device 325 and/or removable storage media 340) in the form of program instructions accessible to the one or more processor(s) 305, which when executed by the one or more processor(s) 305 cause the processor to perform various financial advisory methodologies described further below.

Components described above are meant only to exemplify various possibilities. In no way should the aforementioned exemplary computer system limit the scope of the invention.

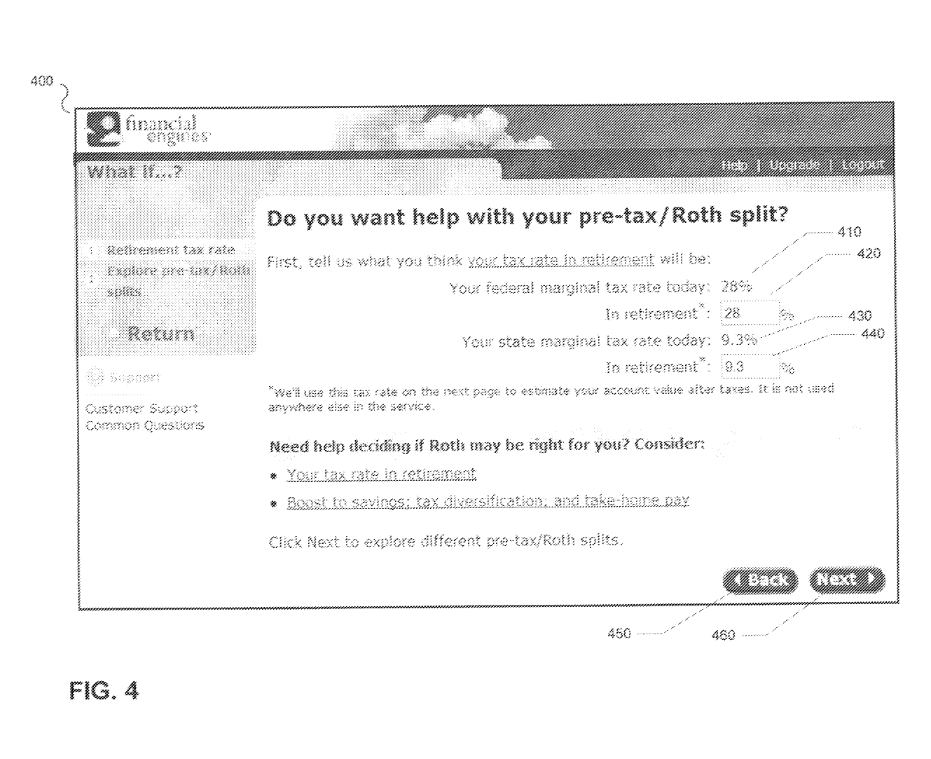

FIG. 4 illustrates a tax rate input screen 400 in accordance with an embodiment of the present invention. In one embodiment, a user is presented with the tax rate input screen 400 responsive to indicating a desire to initiate alternative scenario generation or “what if” capabilities that allow interactive exploration of forecast and take-home pay consequences of different pre-tax/Roth splits coupled with different annual contribution amounts. In some embodiments, these “what if” capabilities might be initiated responsive to user selection of an alert or notification generated by monitoring module 250 indicating the user may wish to review the current savings split between pre-tax and Roth savings. For example, monitoring module 250 may identify an opportunity for the investor to increase take-home pay while achieving an equal or better retirement income forecast or the monitoring module 250 may identify an opportunity for the investor to maintain his/her current take-home pay and achieve a better retirement income forecast.

According to the present example, before exploring pre-tax/Roth saving alternatives, information regarding the investor's current and/or estimated retirement tax rates are gathered from the user. This tax information allows information regarding an after tax value of the account at issue to be estimated. In one embodiment, the investor's current federal marginal tax rate and current state marginal tax rate are already known or estimated and displayed in text fields 410 and 430, respectively. In alternative embodiments, this information may be initialized and/or edited by the user. Tax rate input screen 400 may also prompt the user to provide an estimated retirement federal marginal tax rate in text entry field 420 and an estimated retirement state marginal tax rate in text entry field 440.

After supplying the appropriate tax information, the user may select the “Next” button 460 to navigate to the next screen. Alternatively, the user may select the “Back” button 450 to return to the user interface screen they were viewing prior to navigating to the Tax rate input screen 400.

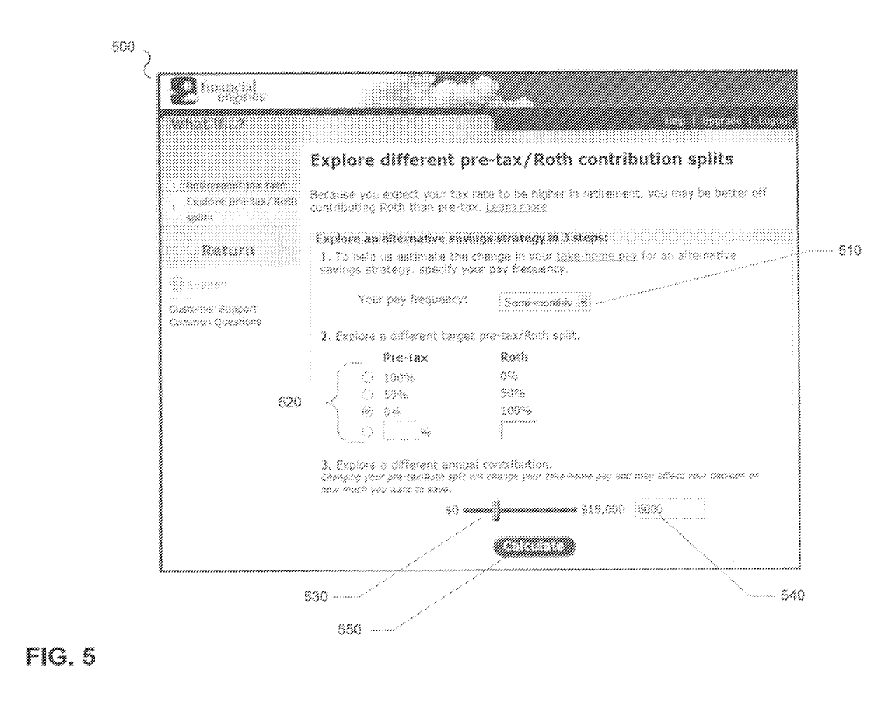

FIG. 5 illustrates a pre-tax/Roth contribution splits and annual contribution amounts input screen 500 framed with some initial split guidance in accordance with an embodiment of the present invention. In one embodiment, the pre-tax/Roth contribution splits and annual contribution amounts input screen 500 is presented to the user responsive to selection of the “Next” button 460 on the tax rate input screen 400.

According to the current example, the user provides information regarding the investor's pay frequency (e.g., semi-monthly, weekly, bi-weekly or monthly) by selecting a corresponding entry from a drop-down list 510.

In one embodiment, the user may select a predefined pre-tax/Roth split (e.g., 100%/0%, 50%/50% and 0%/100%) or define an alternative split by selecting an appropriate one of the radio buttons 520. Upon navigating to the pre-tax/Roth contribution splits and annual contribution amounts input screen 500, the selected radio button may correspond to the current split being implemented for the account at issue. Alternatively, if the user initiated the “what if” processing responsive to selection of an alert, the selected radio button may correspond to a recommended split.

In some embodiments, alternatively or additionally, a “Recommend Split” button (not shown) may be provided, which, when selected by the user, causes various split scenarios to be compared while maintaining the investor's current take-home pay. The split between pre-tax and Roth savings may then be automatically set for the user to the split that produces the highest estimated account value after taxes taking into consideration employer match (if any) and after-tax savings spillover (if applicable).

The user may also (or alternatively) explore the effect of the investor making a different periodic (e.g., annual) contribution by manipulating a slider bar 530 or keying a value into numeric entry field 540. In one embodiment, the maximum annual contribution value associated with slider bar 530 corresponds to the application of both plan limits and the maximum annual contribution limit allowed by law for the tax year at issue. This embodiment takes into consideration any plan provision allowing pre-tax and Roth (including age 50+ catch-up contributions) to spill over into after-tax savings once the maximum contribution limit allowed by law for the tax year at issue is reached).

In one embodiment, the contribution period reflected by slider bar 530 may correspond to the user-specified pay frequency 510. In such an embodiment, when pay frequency 510 is weekly, for example, then positioning of the slider bar 530 as well as associated displayed numeric values may represent a weekly contribution amount. Similarly, when pay frequency 510 is specified as monthly, then positioning of the slider bar 530 as well as associated displayed numeric values may represent a monthly contribution amount.

When the desired pre-tax/Roth split and annual contribution are reflected by the user interface tools depicted on the pre-tax/Roth contribution splits and annual contribution amounts input screen 500, the user may select the “Calculate” button to receive information regarding the user-specified alternative savings plan.

According to one embodiment, the “Calculate” button 550 of the pre-tax/Roth contribution splits and annual contribution amounts input screen 500 may be disabled until the user has created an alternative savings strategy in which a target pre-tax/Roth split different than that of the current savings strategy or a different annual contribution than that of the current savings strategy has been specified by the user.

Various other user input mechanisms are contemplated. For example, information regarding the investor's pay frequency, target pre-tax/Roth split and annual contribution may be distributed over multiple user interface screens. Alternatively, more or fewer options may be available to the user. For example, more resolution may be provided in relation to the range of possible pre-tax/Roth splits (e.g., 5% or 10% increments rather than the 50% increments shown in the present example). Similarly, the information regarding the investor's pay frequency, target pre-tax/Roth split and/or annual contribution may be input via different user interface tools, including, but not limited to slider bars, radio buttons, drop-down lists, text/numeric entry fields and the like.

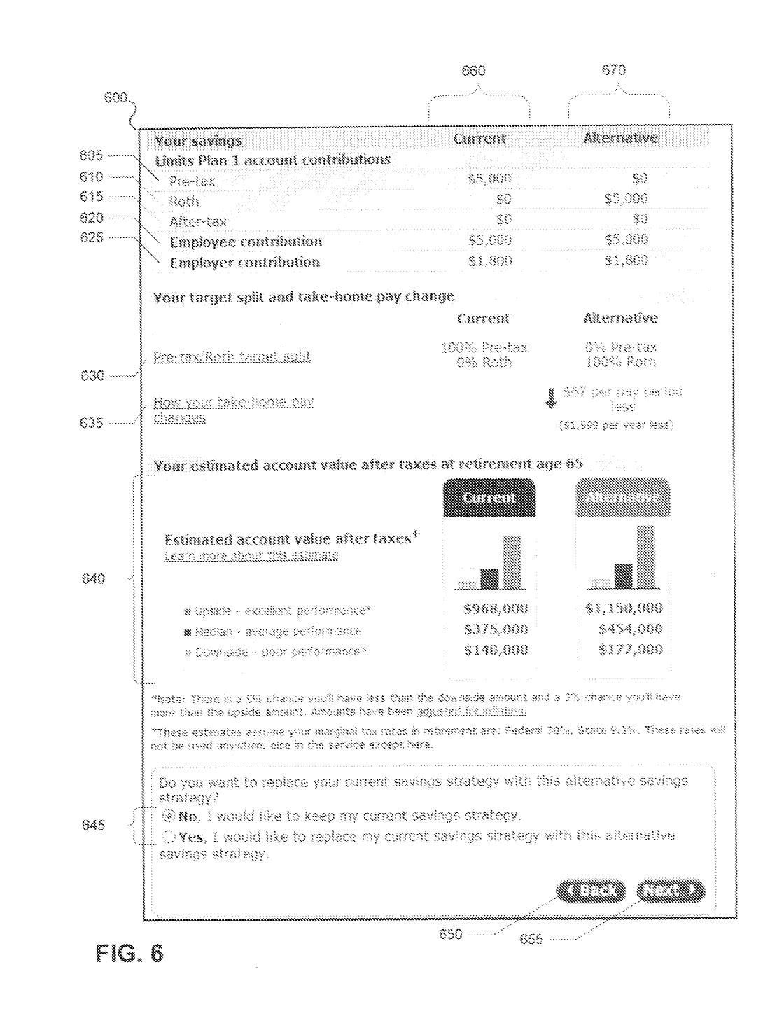

FIG. 6 illustrates an analysis screen 600 in accordance with an embodiment of the present invention. In one embodiment, analysis screen 600 is presented to the user responsive to selection of the “Calculate” button 550 on the pre-tax/Roth contribution splits and annual contribution amounts input screen 500. Analysis screen 600 may present information to assist the user in connection with evaluating the investor's current savings plan and the alternative savings plan. In one embodiment, a side-by-side comparison between the investor's current savings plan (e.g., input and output values listed in column 660) and the alternative savings plan (e.g., input and output values listed in column 670) being explored includes information regarding the investor's savings, pre-tax/Roth target split, take-home pay change and estimated account values at retirement.

According to the current example, the side-by-side comparison between the current and alternative savings plans includes information regarding pre-tax contributions 605, Roth contributions 610, after-tax contributions 615, total employee contributions 620, employer contribution 625 (e.g., employer matching funds), pre-tax/Roth target split 630, change in take-home pay 635 and estimated account values after taxes 640.

In the analysis screen 600 depicted, the user has changed from a pre-tax/Roth split of 100% and 0%, respectively, to 0% and 100%, respectively. As such, the investor's pre-tax contribution 605 is currently $5,000 under the current savings plan and changes to $0 pursuant to the alternative savings plan under consideration. Similarly, the investor's Roth contribution is $0 under the current savings plan and increases to $5,000 according to the alternative savings plan.

For purposes of allowing the user to evaluate the effect of the alternative savings plan on the investor's cash flow, the analysis screen 600 indicates the relative change to take-home pay. In this case, switching from pre-tax to Roth savings reduces the investor's take-home pay by $67 per pay period or $1,599 per year.

At the bottom of the analysis screen 600, the user is provided with an opportunity to replace the current savings strategy by the alternative savings strategy by selecting among radio buttons 645. The user may also explore a different pre-tax/Roth contribution split and/or different annual contribution by returning to the pre-tax/Roth contribution splits and annual contribution amounts input screen 500 by selecting the “Back” button 650. When the user is done exploring split and/or contribution variations, the user may exit the “what if” processing by selecting the “Next” button 655. Depending upon the state of radio buttons 645, variables representing the current savings plan will be preserved or replaced with those representing the alternative savings plan.

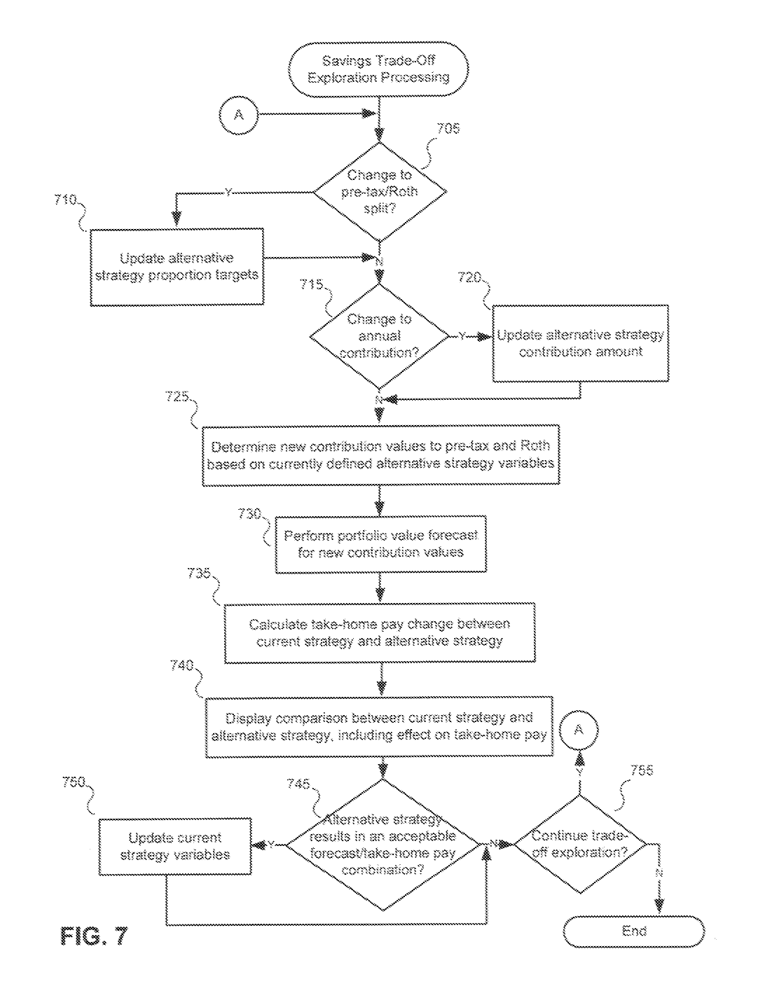

FIG. 7 is a flow diagram illustrating user-driven savings trade-off exploration processing in accordance with an embodiment of the present invention. Depending upon the particular implementation, the various process and decision blocks described herein may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction.

In general, the savings trade-off exploration or “what if” processing discussed below is performed based on the current set of financial product holdings in the account (or portion thereof) at issue. In one embodiment, the result of any increase or decrease in annual contributions are distributed on a pro-rata basis among those financial products already represented within the account and relative percentages of holdings in a financial product to the account as a whole are maintained. As a result, prior to initiating the processing described with reference to FIG. 7, it is assumed that a financial product selection process of some sort has already been performed. In one embodiment, the financial selection process may involve a portfolio optimization process such as that described in U.S. Pat. No. 7,016,870, which is incorporated by reference in its entirety for all purposes.

At decision block 705, a determination is made regarding whether the user has expressed an interest in evaluating an alternative savings strategy by making a change to a pre-tax/Roth split associated with a current savings strategy. In one embodiment, this determination is made with reference to a user interface screen, such as pre-tax/Roth contribution splits and annual contribution amounts input screen 500, and graphical input tools, such as radio buttons 520. According to the current example, if the currently specified pre-tax/Roth split is different than that of the current savings plan, then processing branches to block 710; otherwise processing continues with decision block 715.

At block 710, variables representative of a pre-tax/Roth split for the alternative savings strategy are updated to reflect the user-specified pre-tax/Roth split to which the user would like to compare to the current savings strategy.

At decision block 715, a determination is made regarding whether the user has expressed an interest in evaluating an alternative savings strategy by making a change to an annual contribution associated with a current savings strategy. As above, this determination may be made with reference to a user interface screen, such as pre-tax/Roth contribution splits and annual contribution amounts input screen 500, and graphical input tools, such as slider bar 530. According to the current example, if the currently specified annual contribution is different than that of the current savings plan, then processing branches to block 720; otherwise processing continues with decision block 725.

At block 720, one or more variables representative of an annual contribution for the alternative savings strategy are updated to reflect the user-specified annual contribution to which the user would like to compare to the current savings strategy.

To the extent an alternative savings plan differing from the current savings plan has been specified (e.g., either (i) the selected radio button corresponds to a pre-tax/Roth split different than the pre-tax/Roth split associated with the current savings strategy or (ii) an annual contribution different than that represented by the current savings strategy is specified by the user) then a comparison between the two different savings strategies can be performed beginning with block 725.

At block 725, based on the currently defined alternative strategy variables, contribution values to pre-tax and Roth are determined for the alternative savings strategy.

At block 730, a forecast of the portfolio value for the account is made based on the alternative savings strategy. Below, various methodologies are described which allow return scenarios for portfolio allocations to be simulated. These or other existing or future forecasting mechanisms may be employed. Based on the disclosure provided herein, one of ordinary skill in the art will appreciate a variety of ways in which such a forecast may be performed, including, but not limited to, use of deterministic approaches where historical figures are used as a guide to estimate a portfolio's future returns, use of tools for probabilistic forecasting, such as Monte Carlo Simulation and the forecasting approach described in U.S. Pat. No. 7,016,870, which has previously been incorporated by reference herein.

At block 735, take-home pay change, if any, between the current savings strategy and the alternative savings strategy is calculated. A take-home pay change can result from a change to annual contributions or from a change to the pre-tax/Roth split. Because taxes are paid in advance for Roth contributions and deferred for pre-tax contributions, switching from pre-tax savings to Roth savings decreases take-home pay and switching from Roth savings to pre-tax savings increases take-home pay. For example, consider an individual making a $100,000 annual salary, facing a 33% tax rate. If he/she saves $10,000 pre-tax dollars, his/her take-home pay is $60,300. If he/she were to save the same in Roth dollars, his/her take-home pay would fall to $57,000. The equivalent Roth savings is $6,700, which leaves take-home pay at the original $60,300.

In practice, some individuals switching from pre-tax to Roth might maintain the same nominal saving rate. This is of course a net increase in tax-adjusted saving and a reduction in take-home pay. While many people would benefit from increased retirement saving, any perceived equivalence of savings between pre-tax and Roth dollars is a “tax illusion.” Ultimately, one can think of the savings decision as two-fold: first decide how much take-home pay can be sacrificed, and then choose between the pre-tax and Roth forms of saving. Advantageously, embodiments of the present invention allow interactive exploration of forecast and take-home pay consequences of different pre-tax/Roth splits coupled with different annual contribution amounts by making the user aware of such consequences.

At block 740, a comparison between the current savings strategy and the alternative savings strategy, including the effect on take-home pay, is displayed to the user. In one embodiment, the comparison is displayed in a form similar to that illustrated by FIG. 6.

At block 745, the user makes a decision regarding whether the alternative savings plan represents an acceptable forecast and take-home pay combination. If the user indicates he/she would like to replace the current savings strategy with the alternative savings plan, then processing branches to block 750; otherwise processing continues with decision block 755.

At block 750, the current savings plan variables are replaced with those of the alternative savings plan. Thus, the alternative savings plan now becomes the current savings plan.

At decision block 755, the user determines whether he/she would like to continue trade-off exploration. If the user wishes to further increase take-home pay, for example, then he/she may either increase the pre-tax fraction or percentage relative to Roth or decrease the annual contribution. If the user wishes to further increase the forecast, for example, then he/she may either adjust the pre-tax/Roth split again or increase the annual contribution. If the user indicates he/she would like to continue trade-off exploration, then processing loops back to decision block 705; otherwise trade-off exploration processing is complete.

Note that as implied by the exemplary nature of this diagram, there is no requirement that the above listed steps be performed in any particular order. Furthermore, any of the above steps could be omitted, and other steps could be added where relevant to the specific implementation.

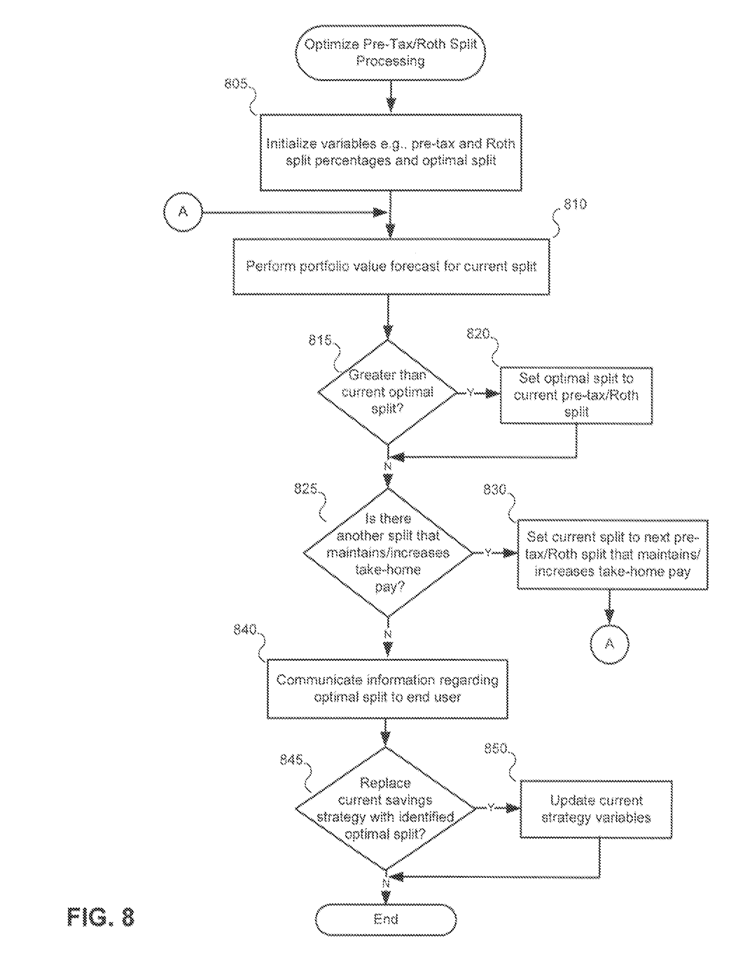

FIG. 8 is a flow diagram illustrating a process of automatically identifying an alternative strategy that increases/maintains take-home pay while maintaining/increasing forecasted account value in accordance with an embodiment of the present invention. In many situations user may wish to identify potential strategies which maintain or even increase take-home pay. In some of these situations, the forecast may improve if the appropriate saving strategy is chosen. For example, a person facing higher tax rates in retirement would normally wish to save in the form of Roth (paying taxes now instead of in the future). If he/she is currently saving in the inferior form of pre-tax, then switching to Roth offers economic benefits that may be shared between increased take-home pay and an increased retirement portfolio. The process described below illustrates a method of finding these alternative strategies

As above, the alternative savings strategy identification process is performed based on the current set of financial product holdings in the account at issue. In one embodiment, the result of any increase or decrease in annual contributions are distributed on a pro-rata basis among those financial products already represented within the account and relative percentages of holdings in a financial product to the account as a whole are maintained. Consequently, as indicated above, prior to initiating the processing described with reference to FIG. 8, it is assumed that an appropriate financial product selection process of some sort has already been performed.

At block 805, variables relating to the current pre-tax and Roth split percentages and the currently identified optimal split are initialized. In one embodiment, the initial state corresponds to the investor's current savings plan.

At block 810, a forecast is generated for the future portfolio value at a user-specified time of retirement, for example, based on the currently defined pre-tax/Roth split. As indicated above, this forecast may be performed in accordance with any known or future simulation-based or other approach.

At decision block 815, a determination is made whether the current forecast is greater than that of the current optimal split. If so, then processing branches to block 820; otherwise processing continues with decision block 825.

At block 820, information regarding the currently identified optimal split, such as the pre-tax and Roth split percentages and the forecasted future portfolio value are stored and the current pre-tax/Roth split becomes the currently identified optimal split.

At decision block 825, a determination is made regarding whether another split exists that maintains/increases take-home pay. If so, processing branches to block 830; otherwise processing continues to block 840.

At block 830, the current split is set to the next pre-tax/Roth split that maintains/increases the investor's take-home pay and processing loops back to block 810.

At block 840, it has been determined that there are no additional splits that maintain/increase take-home pay. Consequently, the current state of the optimal split variables identify the split, if any, associated with the best forecast and which maintains/increases take-home pay. According to the present example, at this point, information regarding the optimal split may be communicated to the end user. The information may be in the form of user interface screen 500, for example, to enable the user to compare the current savings plan to the alternative savings plan identified.

At decision block 845, the user is provided with an opportunity to replace the investor's current savings plan with the alternative savings plan, which represents the optimal pre-tax/Roth split that maintains or increases the investor's take-home pay. If the user indicates the current savings plan is to be replaced with the alternative savings plan, then processing branches to block 850; otherwise pre-tax/Roth split optimization processing is complete.

At block 850, the current savings plan variables are replaced with the alternative savings plan variables and future contributions by the investor are invested in accordance with the newly identified alternative savings plan.

Note that as implied by the exemplary nature of this diagram, there is no requirement that the above listed steps be performed in any particular order. Furthermore, any of the above steps could be omitted, and other steps could be added where relevant to the specific implementation.

Various methodologies are now described which allow return scenarios for portfolio allocations to be simulated. Briefly, according to one embodiment, fundamental economic and financial forces are modeled using a pricing kernel model that provides projected returns on a plurality of asset classes (core asset classes) conditional on a set of state variables that capture economic conditions. The core asset classes in combination with additional asset class estimates that are conditioned on the core asset classes comprise a model (hereinafter “the factor model”) of a comprehensive set of asset classes that span the universe of typical investment products. A factor model is a return-generating function that attributes the return on a financial product, such as a security, to the financial product's sensitivity to the movements of various common economic factors. The factor model enables the system to assess how financial products and portfolios will respond to changes in factors or indices to which financial products are exposed. The selection of asset classes may be tailored to address a narrow or broad range of investors. For example, asset classes may be chosen that are relevant only to a particular industry or asset classes may be chosen to span the market range of a broad set of possible investments (e.g. all available mutual funds or individual equities). According to embodiments of the present invention discussed herein, to reach the broadest segment of individual investors, the asset classes selected as factors for the factor model have been chosen to span the range of investments typically available to individual investors in mainstream mutual funds and defined contribution plans.

After generating future scenarios for the factor model, in one embodiment, financial products available to an investor may be mapped onto the factor model. To assure that a portfolio recommended by the system is attainable, it is preferable to generate investment scenarios that include only those financial products that are available to the investor. The available financial products may include, for example, a specific set of mutual funds offered by an employer sponsored 401(k) program. In any event, this mapping of financial products onto the factor model is accomplished by decomposing the returns of individual financial products into exposures to the asset classes employed by the factor model. In this manner, the system learns how each of the financial products available to the investor behaves relative to the asset classes employed by the factor model. In so doing, the system implicitly determines the constraints on feasible exposures to different asset classes faced by an investor given a selected subset of financial products. Given this relationship between the investor's available financial products and the factor model, the system may generate feasible forward-looking investment scenarios. A stochastic simulator may provide information relating to various aspects of financial risk including the risk of not achieving a particular financial goal and short- and long-term financial risks in order to help a user of the financial advisory system deal with and control such financial risks. The system may further advise the user regarding actions that may be taken by the investor (e.g., save more money, retire later, take on additional investment risk, seek opportunities to expand the investment set) to achieve certain financial goals, such as particular retirement standard of living, accumulating a down payment for the purchase of a house, or saving enough money to send a child to college. Other aspects of the present invention allow the user to focus the investor on his/her decisions regarding investment risk, savings, and retirement age while interactively observing the impact of those decisions on the range of possible investment outcomes.

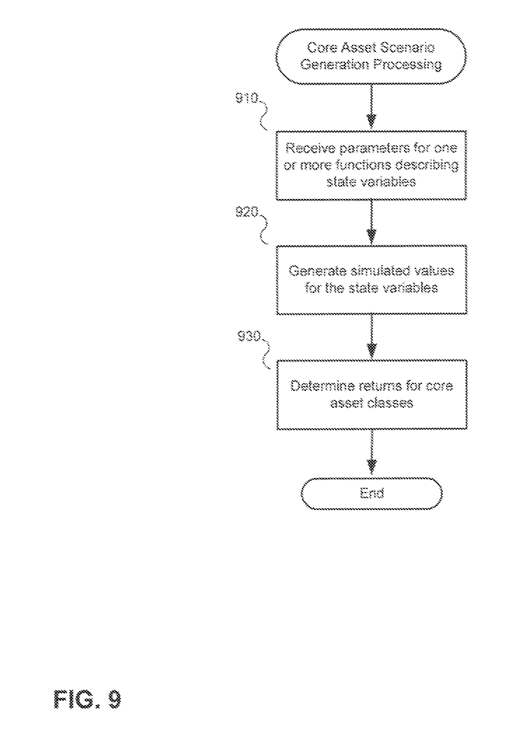

FIG. 9 is a flow diagram illustrating core asset class scenario generation according to one embodiment of the present invention. In embodiments of the present invention, core assets may include, but are not limited to, one or more of short-term US government bonds, long-term US government bonds, and US equities. At block 910, parameters for one or more functions describing state variables are received. The state variables may include general economic factors, such as inflation, interest rates, dividend growth, and other variables. Typically, state variables are described by econometric models that are estimated based on observed historical data.

At block 920, these parameters are used to generate simulated values for the state variables. The process begins with a set of initial conditions for each of the state variables. Subsequent values are generated by iterating the state variable function to generate new values conditional on previously determined values and a randomly drawn innovation term. In some embodiments, the state variable functions may be deterministic rather than stochastic. In general, the randomly drawn innovation terms for the state variable functions may be correlated with a fixed or conditional covariance matrix.

At block 930, returns for core asset classes are generated conditional on the values of the state variables. Returns of core asset classes may be described by a function of a constant, previously determined core asset class returns, previously determined values of the state variables, and a random innovation term. Subsequent values are generated by iterating a core asset class function to generate new values conditional on previously determined values and a random draws of the innovation term. In some embodiments, the core asset class functions may be deterministic rather than stochastic. In general, the randomly drawn innovation terms for the core asset class functions may be correlated with a fixed or conditional covariance matrix.

In alternative embodiments, blocks 910 and 920 may be omitted and the core asset class returns may be generated directly in an unconditional manner. A simple example of such a model would be a function consisting of a constant and a randomly drawn innovation term.

Another approach would be to jointly generate core asset class returns based on a model that incorporates a stochastic process (also referred to as a pricing kernel) that limits the prices on the assets and payoffs in such a way that no arbitrage is possible. By further integrating a dividend process with the other parameters an arbitrage free result can be ensured across both stocks and bonds. Further description of such a pricing kernel is disclosed in U.S. Pat. No. 6,125,355, assigned to the assignee of the present invention, the contents of which are hereby incorporated by reference.

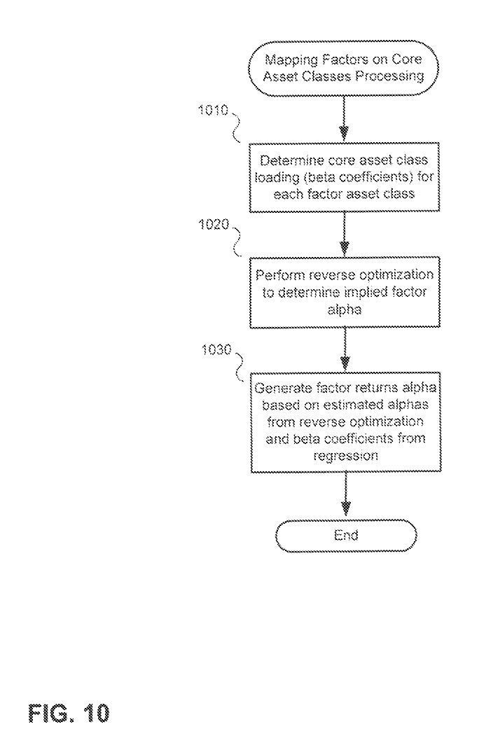

Referring now to FIG. 10, factor model asset scenario generation will now be described. A scenario in this context is a set of projected future values for factors. According to this embodiment, the factors may be mapped onto the core asset factors by the following equation:

rᵢᵢ=αᵢ+β₁ᵢST_Bondsₜ+β₂ᵢLt_Bondsₜ+β₃ᵢUS_Stocksₜ+εᵢ (EQ #1)

where

rᵢᵢ represents the return for a factor, i, at time t

βⱼᵢ represent slope coefficients or the sensitivity of the factor i to core asset class j

ST_BONDSₜ is a core asset class representing the returns estimated by the pricing module 205 for short-term US government bonds at time t

LT_BONDSₜ is a core asset class representing the returns estimated by the pricing module 205 for long-term US government bonds at time t.

US_STOCKSₜ is a core asset class representing the returns estimated by the pricing module 205 for US stocks at time t.

αᵢ is a constant representing the average returns of factor asset class i relative to the core asset class exposures (“factor alpha”).

εᵢ is a residual random variable representing the returns of factor asset class i that are not explained by the core asset class exposures (“residual variance”).

At block 1010, the beta coefficients (also referred to as the loadings or slope coefficients) for each of the core asset classes are determined. According to one embodiment, a regression is run to estimate the values of the beta coefficients. The regression methodology may or may not include restrictions on the sign or magnitudes of the estimated beta coefficients. In particular, in one embodiment of the present invention, the coefficients may be restricted to sum to one. However, in other embodiments, there may be no restrictions placed on the estimated beta coefficients.

Importantly, the alpha estimated by the regression is not used for generating the factor model asset scenarios. Estimates of alpha based on historical data are extremely noisy because the variance of the expected returns process is quite high relative to the mean. Based on limited sample data, the estimated alphas are poor predictors of future expected returns. At any rate, according to one embodiment, a novel way of estimating the alpha coefficients that reduces the probability of statistical error is used in the calibration of the factor model. This process imposes macroconsistency on the factor model by estimating the alpha coefficients relative to a known efficient portfolio, namely the Market Portfolio. Macroconsistency is the property that expected returns for the factor asset classes are consistent with an observed market equilibrium; that is, estimated returns will result in markets clearing under reasonable assumptions. The Market Portfolio is the portfolio defined by the aggregate holdings of all asset classes. It is a portfolio consisting of a value-weighted investment in all factor asset classes. Therefore, in the present example, macroconsistency may be achieved by setting the proportion invested in each factor equal to the percentage of the total market capitalization represented by the particular factor asset class.

At block 1020, a reverse optimization may be performed to determine the implied factor alpha for each factor based upon the holdings in the Market Portfolio. This procedure determines a set of factor alphas that guarantee consistency with the observed market equilibrium. In a standard portfolio optimization, Quadratic Programming (QP) is employed to maximize the following utility function:

$${E ( r )}^{T} X - \frac{( {X}^{T} C ( r ) X )}{τ} , {u}^{T} X = 1 \qquad ( EQ \#2 )$$

where,

E(r) represents expected returns for the asset classes,

C(r) represents the covariance matrix for the asset class returns,

Tau represents a risk tolerance value,

X is a matrix representing the proportionate holdings of each asset class of an optimal portfolio comprising the asset classes, and

u is a vector of all ones.

C(r) may be estimated from historical returns data or more advantageously may be estimated from projected returns generated by a pricing kernel model.

Inputs to a standard portfolio optimization problem include E(r), C(r), and Tau and QP is used to determine X. However, in this case, X is given by the Market Portfolio, as described above, and a reverse optimization solves for E(r) by simply backing out the expected returns that yield X equal to the proportions of the Market Portfolio.

Quadratic Programming (QP) is a technique for solving an optimization problem involving a quadratic (squared terms) objective function with linear equality and/or inequality constraints. A number of different QP techniques exist, each with different properties. For example, some are better for suited for small problems, while others are better suited for large problems. Some are better for problems with very few constraints and some are better for problems with a large number of constraints. According to one embodiment of the present invention, when QP is called for, an approach referred to as an “active set” method is employed herein. The active set method is explained in Gill, Murray, and Wright, “Practical Optimization,” Academic Press, 1981, Chapter 5.

In one embodiment, the first order conditions for the optimization of Equation #2 are:

$$E ( r ) = 2 C ( r ) \frac{X}{τ} + Ku \qquad ( EQ \#3 )$$

where K is a Lagrange multiplier; hence, knowing the Market Portfolio and any two values of E(r) (for example, the risk free rate and the return on US equities) the full set of expected returns that are consistent with the Market Portfolio can be derived. The two values of E(r) required for the reverse optimization follow from the expected returns of the core assets.

At block 1030, factor returns may be generated based upon the estimated alphas from block 1020 and the estimated beta coefficients from block 1010. As many factor model asset scenarios as are desired may be generated using Equation #1 and random draws for the innovation value. A random value for εᵢ is selected for each evaluation of Equation #1. According to one embodiment, εᵢ is distributed as a standard normal variate. In other words, εᵢ is drawn from a standard normal distribution with a mean of 0 and a standard deviation of 1.

Advantageously, in this mariner, a means of simulating future economic scenarios and determining the interrelation of asset classes is provided.

As discussed above, one method of determining how a financial product behaves relative to a set of factor asset classes is to perform returns-based style analysis. According to one embodiment, returns for a given financial product may be estimated as a function of returns in terms of one or more of the factor asset classes described above based on the following equation:

r_{ft}·α_{ft}+S_{f1}rₗₜ+S_{f2}r₂ₜ+ . . . +S_{fn}rₙₜ+εₜ (EQ #4)

where,

α_{ft} is the mean of the left over residual risk (“selection variance”) of the financial product return that cannot be explained in terms of the factor loadings.

r_{ft} is the return for financial product fat time t,

rₙₜ is the return for factor n at time t, and

εₜ is the residual at time t that is unexplained by movements in the factor returns.

The financial product exposure module 215 computes the factor asset class exposures for a particular fund via a nonlinear estimation procedure. The exposure estimates, S_{fn}, are called style coefficients, and are generally restricted to the range [0,1] and to sum to one. In other embodiments, these restrictions may be relaxed (for example, with financial products that may involve short positions, the coefficients could be negative). Alpha may be thought of as a measure of the relative under or over performance of a particular fund relative to its passive style benchmark.

At this point in the process, the goal is to take any individual group of assets that people might hold, such as a group of mutual funds, and map those assets onto the factor model, thus allowing portfolios to be simulated forward in time. According to one embodiment, this mapping is achieved with what is referred to as “returns-based style analysis” as described in Sharpe [1992], which is hereby incorporated by reference. Generally, the term “style analysis” refers to determining a financial product's exposure to changes in the returns of a set of major asset classes using Quadratic Programming or similar techniques.

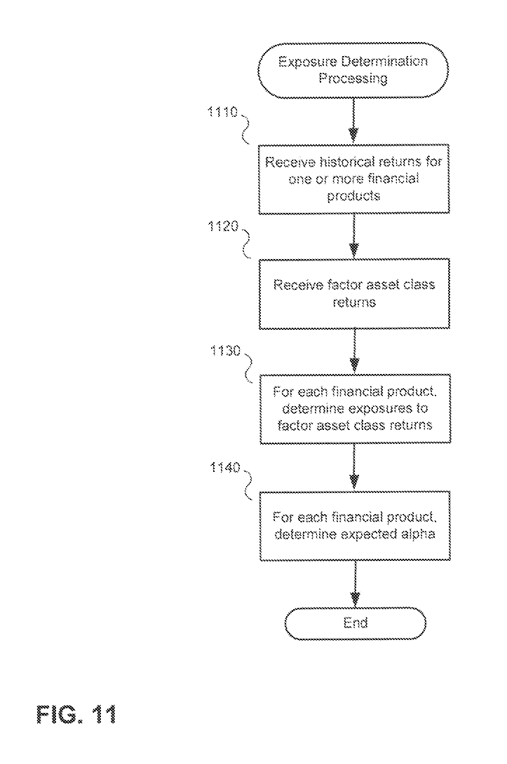

FIG. 11 is a flow diagram illustrating a method of determining a financial product's exposures to factor asset class returns according to one embodiment of the present invention. At block 1110, the historical returns for one or more financial products to be analyzed are received. According to one embodiment, the financial product exposure module 215 may reside on a server device and periodically retrieve the historical return data from a historical database stored in another portion of the same computer system, such as RAM, a hard disk, an optical disc, or other storage device. Alternatively, the financial product exposure module 215 may reside on a client system and receive the historical return data from a server device as needed. At block 1120, factor asset class returns are received.

At block 1130, QP techniques or the like are employed to determine estimated exposures (the S coefficients) to the factor asset class returns.

At block 1140, for each financial product, expected future alpha is determined for each subperiod of the desired scenario period. With regards to mutual funds or related financial products, for example, historical alpha alone is not a good estimate of future alpha. That is, a given mutual fund or related financial product will not continue to outperform/under perform its peers indefinitely into the future. Rather, empirical evidence suggests that over performance may partially persist over one to two years while under performance may persist somewhat longer (see for example, Carhart, Mark M. “On Persistence in Mutual Fund Performance.” Journal of Finance, March 1997, Volume 52 No. 1, pp. 57-82).

For example, future alpha may depend upon a number of factors, such as turnover, expense ratio, and historical alpha. Importantly, one or more of these factors may be more or less important for particular types of funds. For example, it is much more costly to buy and sell in emerging markets as compared to the market for large capitalization US equities. In contrast, bond turnover can be achieved at a much lower cost, therefore, turnover has much less affect on the future alpha of a bond fund than an equity fund. Consequently, the penalty for turnover may be higher for emerging market funds compared to large cap U.S. equities and bond funds. Improved results may be achieved by taking into account additional characteristics of the fund, such as the fact that the fund is an index fund and the size of the fund as measured by total net assets, for example.

According to one embodiment of the present invention, a more sophisticated model may be employed for determining future alpha for each fund:

αₜ−α_{base}+ρ^{t}(α_{historical}−α_{base}) (EQ 45)

where,

α_{base} is the baseline prediction for future Alpha of the fund

Rho, governs the speed of decay from α_{historical} to α_{base}

α_{historical} is Alpha estimated in Equation #4

According to one embodiment,

α_{base}=C+β₁Expense_Ratio+β₂Turnover+β₃Fund−_Size (EQ 46)

where the parameters are estimated separately for each of four different classes of funds: US equity, foreign equity, taxable bond, nontaxable bond. These parameters may be estimated using conventional econometric techniques, such as ordinary least squares (OLS). According to one embodiment, Rho is estimated by first calculating historical deviations from α_{base} (“residual alpha”) and then estimating Rho as the first order serial correlation of the residual alpha series.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A computer-implemented method comprising:
determining, by a split optimization module, whether there exists an alternative retirement savings strategy for an investor that both (i) maintains take-home pay of the investor and (ii) increases a forecasted after tax value of a retirement portfolio of the investor as compared to a current retirement savings strategy of the investor;
if the alternative retirement savings strategy exists, then presenting, by a user interface module, information associated with the alternative retirement savings strategy, including information regarding a recommended periodic contribution by the investor to be invested in the retirement portfolio and information regarding a target proportion of the recommended periodic contribution that should be made pre-tax and post-tax; and
wherein the split optimization module and the user interface module are implemented in one or more processors and one or more computer-readable media of one or more computer systems, the one or more computer-readable media having instructions tangibly embodied therein representing the split optimization module and the user interface module that are executable by the one or more processors.

2. The method of claim 1, wherein the pre-tax contributions comprise contributions to a traditional component of a 401(k) plan or a 403(b) plan and the post-tax contributions comprise contributions to a Roth component of the 401(k) plan or the 403(b) plan.

3. The method of claim 1, further comprising replacing the current retirement savings strategy with the alternative retirement savings strategy.

4. A computer-implemented method comprising:
determining, by a split optimization module, whether there exists an alternative retirement savings strategy for an investor that both (i) increases take-home pay of the investor and (ii) maintains or increases a forecasted after tax value of a retirement portfolio of the investor as compared to a current retirement savings strategy of the investor;
if the alternative retirement savings strategy exists, then presenting, by a user interface module, information associated with the alternative retirement savings strategy, including information regarding a recommended periodic contribution by the investor to be invested in the retirement portfolio and information regarding a target proportion of the recommended periodic contribution that should be made pre-tax and post-tax; and
wherein the split optimization module and the user interface module are implemented in one or more processors and one or more computer-readable media of one or more computer systems, the one or more computer-readable media having instructions tangibly embodied therein representing the split optimization module and the user interface module that are executable by the one or more processors.

5. The method of claim 4, wherein the pre-tax contributions comprise contributions to a traditional component of a 401(k) plan or a 403(b) plan and the post-tax contributions comprise contributions to a Roth component of the 401(k) plan or the 403(b) plan.

6. The method of claim 4, further comprising replacing the current retirement savings strategy with the alternative retirement savings strategy.

7. A non-transitory computer-readable storage medium tangibly embodying a set of instructions, which when executed by one or more processors of one or more computer systems, cause the one or more processors to perform a method for identifying an alternative retirement savings strategy for an investor, the method comprising:
determining, by a split optimization module, whether there exists an alternative retirement savings strategy for an investor that both (i) maintains take-home pay of the investor and (ii) increases a forecasted after tax value of a retirement portfolio of the investor as compared to a current retirement savings strategy of the investor; and
if the alternative retirement savings strategy exists, then presenting, by a user interface module, information associated with the alternative retirement savings strategy, including information regarding a recommended periodic contribution by the investor to be invested in the retirement portfolio and information regarding a target proportion of the recommended periodic contribution that should be made pre-tax and post-tax.

8. The non-transitory computer-readable storage medium of claim 7, wherein the pre-tax contributions comprise contributions to a traditional component of a 401(k) plan or a 403(b) plan and the post-tax contributions comprise contributions to a Roth component of the 401(k) plan or the 403(b) plan.

9. The non-transitory computer-readable storage medium of claim 7, wherein the method further comprises replacing the current retirement savings strategy with the alternative retirement savings strategy.

10. A non-transitory computer-readable storage medium tangibly embodying a set of instructions, which when executed by one or more processors of one or more computer systems, cause the one or more processors to perform a method for identifying an alternative retirement savings strategy for an investor, the method comprising:
determining, by a split optimization module, whether there exists an alternative retirement savings strategy for an investor that both (i) increases take-home pay of the investor and (ii) maintains or increases a forecasted after tax value of a retirement portfolio of the investor as compared to a current retirement savings strategy of the investor; and
if the alternative retirement savings strategy exists, then presenting, by a user interface module, information associated with the alternative retirement savings strategy, including information regarding a recommended periodic contribution by the investor to be invested in the retirement portfolio and information regarding a target proportion of the recommended periodic contribution that should be made pre-tax and post-tax.

11. The non-transitory computer-readable storage medium of claim 10, wherein the pre-tax contributions comprise contributions to a traditional component of a 401(k) plan or a 403(b) plan and the post-tax contributions comprise contributions to a Roth component of the 401(k) plan or the 403(b) plan.

12. The method of claim 10, wherein the method further comprises replacing the current retirement savings strategy with the alternative retirement savings strategy.
